(19) United States
(12) Patent Application Publication
(10) Pub. No.: US 2026/0031613 A1
(43) Pub. Date: Jan. 29, 2026

(54) CONVERTER TOPOLOGY FOR ELECTROLYSIS PLANTS

(71) Applicant: Siemens Aktiengesellschaft, 80333 Munchen (DE)

(72) Inventors: Patrick Hofstetter, Erlangen (DE); Jakub Kucka, Erlangen (DE)

(73) Assignee: Siemens Aktiengesellschaft, 80333 Munchen (DE)

(21) Appl. No.: 19/280,807

(22) Filed: Jul. 25, 2025

(30) Foreign Application Priority Data
Jul. 26, 2024 (EP) 24191050.4

(51) Int. Cl. H02J 1/02; H02J 1/10; H02M 1/14; H02M 3/158; H02M 7/162

(52) U.S. Cl. CPC H02J 1/02; H02J 1/102; H02M 1/143; H02M 3/1582; H02M 7/1623; H02J 2310/18

(57) ABSTRACT

A power supply facility for supplying an electrolysis plant with electrical energy has a rectifier and a first transformer arrangement with a primary side drawing electrical energy from an alternating voltage grid and a secondary side supplying the electrolysis plant with the electrical energy via a DC link. The power supply facility has an additional unit with a second transformer arrangement, a transistor power converter and a DC-DC converter. The primary side of the second transformer arrangement is connected in series with either the primary side or the secondary side of the first transformer arrangement. The transistor power converter is connected to the secondary side of the second transformer arrangement and the DC-DC converter. The DC-DC converter is connected to the DC link of the rectifier.

### CROSS-REFERENCES TO RELATED APPLICATIONS

This application claims the priority of European Patent Application, Serial No. 24191050.4, filed Jul. 26, 2024, pursuant to 35 U.S.C. 119(a)-(d), the content of which is incorporated herein by reference in its entirety as if fully set forth herein.

### BACKGROUND OF THE INVENTION

The invention relates to a power supply facility for supplying an electrolysis plant with electrical energy, in particular to a converter topology for the power supply facility.

The following discussion of related art is provided to assist the reader in understanding the advantages of the invention, and is not to be construed as an admission that this related art is prior art to this invention.

An electrolysis plant requires a high current (often several kA) at a relatively low voltage (usually in the range of several 100 V). The current must be supplied to the electrolysis plant as direct current. In order to supply the electrolysis plant with the required electrical energy from a standard AC voltage grid, a power supply facility is therefore required that performs the corresponding rectification and often also a voltage adjustment.

Rectifiers range in design from simple diode rectifiers and thyristor rectifiers to regenerative transistor power converters. Voltages can be readily adjusted using transformers.

A thyristor rectifiers, although relatively inexpensive, is also relatively inefficient with only partial modulation. Diode rectifiers are not controllable. However, it may be necessary or desirable to adjust the control of the power supply facility in order to be able to compensate for changes in the operation of the electrolysis plant and for voltage fluctuations in the AC voltage grid.

However, thyristor rectifiers as well as diode rectifiers can disadvantageously generate comparatively large system perturbations. These can be ameliorated with additional components which add to the system costs.

One of such perturbations may be a comparatively large current ripple on the DC side. Attempts to compensate for such a current ripple by means of the transistor power converter can also lead to system perturbations. Additionally, a short circuit on the DC side may disadvantageously harm or even destroy an unprotected transistor power converter.

It would therefore be desirable and advantageous to provide an improved power supply facility to obviate prior art shortcomings and to reduce and even compensate system perturbations as well as current ripple.

### SUMMARY OF THE INVENTION

According to one aspect of the present invention, a power supply facility for supplying an electrolysis plant with electrical energy includes a first transformer arrangement and a rectifier, wherein the rectifier draws electrical energy from an AC voltage grid via the first transformer arrangement and supplies the electrolysis plant with the electrical energy drawn from the AC voltage grid via a DC link. The power supply facility has an additional unit with a second transformer arrangement and a transistor power converter, wherein the primary side of the second transformer arrangement is connected in series to the primary side or the secondary side of the first transformer arrangement, and the transistor power converter is connected to the secondary side of the second transformer arrangement and the DC link of the rectifier.

The two transformer arrangements can be designed as mutually separate transformer arrangements. They are often combined to form a common transformer unit. Furthermore, the transformer arrangements may have manually or electronically switchable taps.

According to another aspect of the invention, an operating method for operating such a power supply facility includes controlling the transistor power converter with a control facility such that an amplitude of the AC voltage supplied to the rectifier is set such that the rectifier provides a predetermined voltage level toward the DC link, and system perturbations to the AC voltage grid occurring during operation of the rectifier are compensated as far as possible.

Further aspects of the invention relate to a control program having commands which, when executed by a control facility for such a power supply facility, cause the control facility to control the power supply facility in accordance with such an operating method. And furthermore to a control facility that is programmed with such a control program so that during operation the control facility controls a power supply facility of this type in accordance with an operating method of this type.

According to another advantageous feature of the invention, the additional unit may include a DC-DC converter in addition to the second transformer arrangement and the transistor power converter, the transistor power converter may be connected to the DC-DC converter, and the DC-DC converter may be connected to the DC link of the rectifier.

As a result, the DC-DC converter is arranged between the transistor power converter and the DC link of the rectifier. A DC-DC converter can react considerably faster to a change in control than a transistor power converter. The DC-DC converter is therefore able to at least reduce the current ripple of the DC link of the rectifier. In particular, the DC-DC converter is able to feed desired currents into the DC link of the rectifier in a controlled manner. On account of the reduction or compensation of the current ripple by the DC-DC converter, it is possible for the DC link of the rectifier to have no filter inductance or at least a significantly lower filter inductance than in the prior art. The costs for a filter inductance can therefore be eliminated or at least significantly reduced.

According to another advantageous feature of the invention, the additional unit can be smaller than the rectifier, so that less electrical energy flows via the additional unit than via the rectifier. This design is particularly advantageous from a cost point of view. The amount of electrical energy flowing via the transistor power converter is often only 20% or less, especially 15% or less, of the electrical energy flowing via the rectifier.

According to another advantageous feature of the invention, the DC-DC converter may be designed as an interleaved buck-boost converter. This design is simple and particularly flexible to operate.

According to another advantageous feature of the invention, the DC converter may be designed as a potential-isolating DC-DC converter.

Advantageously, the transistor converter may designed as a voltage rectifier.

The transistor power converter may be designed as a rectifier that only enables unidirectional energy flow. However, as a rule, the transistor power converter may be designed as a converter that enables bidirectional energy flow. This results in a larger range for a specific design of the transistor power converter in which the operation of the power supply facility can be stabilized.

According to another advantageous feature of the invention, the rectifier can be designed as a thyristor rectifier and can be controlled by the control facility in stationary operation with a constant control angle, especially with a control angle of 0°. This design is a particularly advantageous low-cost design.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows an electrolysis plant, a power supply facility and an AC voltage grid,

FIG. 2 shows a modification of FIG. 1,

FIG. 3 shows a transistor power converter,

FIG. 4 shows a DC-DC converter,

FIG. 5 shows a further DC-DC converter, and

FIG. 6 shows a flow chart.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

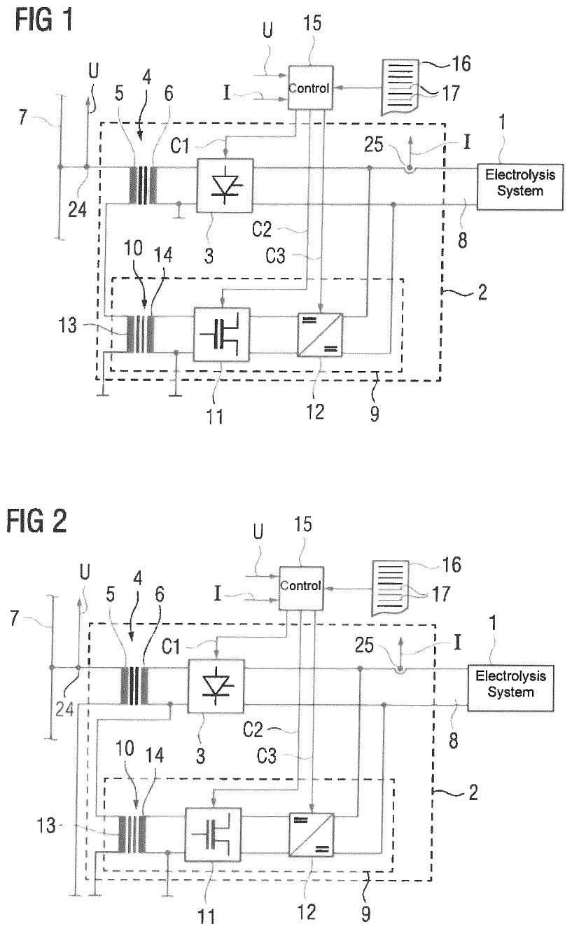

Turning now to FIG. 1, there is shown an electrolysis plant 1 to be supplied with electrical energy by means of a power supply facility 2. For this purpose, the power supply facility 2 initially has a rectifier 3 and a first transformer arrangement 4. The transformer arrangement 4 in turn has a primary side 5 and a secondary side 6. The primary side 5 is connected to an alternating voltage grid 7. The secondary side 6 feeds the rectifier 3. The rectifier 3 thus draws electrical energy from the AC voltage grid 7 via the first transformer arrangement 4. The rectifier 3 rectifies the electrical energy drawn and feeds the rectified electrical energy to the electrolysis plant 1 via a DC link 8. The AC voltage grid 7 is usually multi-phase. Accordingly, the first transformer arrangement 4 is usually also multiphase. In most cases, the number of phases is three. The rectifier 3 is usually embodied as a thyristor rectifier. In individual cases, it can be designed as a diode rectifier.

The power supply facility 2 also has an additional unit 9. The additional unit 9 in turn has a second transformer arrangement 10, a transistor power converter 11 and a DC-DC converter 12. The second transformer arrangement 10 has a primary side 13 and a secondary side 14. The primary side 13 of the second transformer arrangement 10 is connected in series to the primary side 5 of the first transformer arrangement 4. The transistor power converter 11 is connected to the secondary side 14 of the second transformer arrangement 10 on the one hand and to the DC-DC converter 12 on the other hand. The number of phases of the second transformer arrangement 10 and the transistor power converter 11 generally corresponds to the number of phases of the first transformer arrangement 4 and the rectifier 3. The DC-DC converter 12 is finally connected to the DC link 8. It performs a voltage conversion from a DC voltage on the input side to a DC voltage on the output side or vice versa.

The power supply facility 2 is controlled by a control facility 15. In the usual case that the rectifier 3 is designed as a thyristor rectifier, the control facility 15 generates control commands C1, C2, C3 for the thyristor rectifier 3, the transistor power converter 11 and the DC-DC converter 12. If the rectifier 3 is embodied as a diode rectifier, the control facility 15 only generates the control commands C2 and C3 for the transistor power converter 11 and the DC-DC converter 12. The mode of operation of the control facility 15 is determined by a control program 16, with which the control facility 15 is programmed. The control program 16 comprises commands 17. The commands 17 are program commands, i.e. commands that are executed by the control facility 15. When they are carried out by the control device 15, they cause the control device 15 to control the power supply facility 2 accordingly. The associated operating method will be explained later.

FIG. 2 shows a minor modification of FIG. 1. The difference from FIG. 1 consists in the primary side 13 of the second transformer arrangement 10 not being connected in series to the primary side 5 of the first transformer arrangement 4 but instead to the secondary side 6 of the transformer arrangement 4. Furthermore, the design is identical to FIG. 1.

According to FIGS. 1 and 2, the additional unit 9 is advantageously smaller than the rectifier 3. Less electrical energy therefore flows via the additional unit 9 than via the rectifier 3. The smaller dimensioning can be seen in FIGS. 1 and 2 by the fact that the transistor power converter 11 and the DC-DC converter 12 are smaller than the rectifier 3.

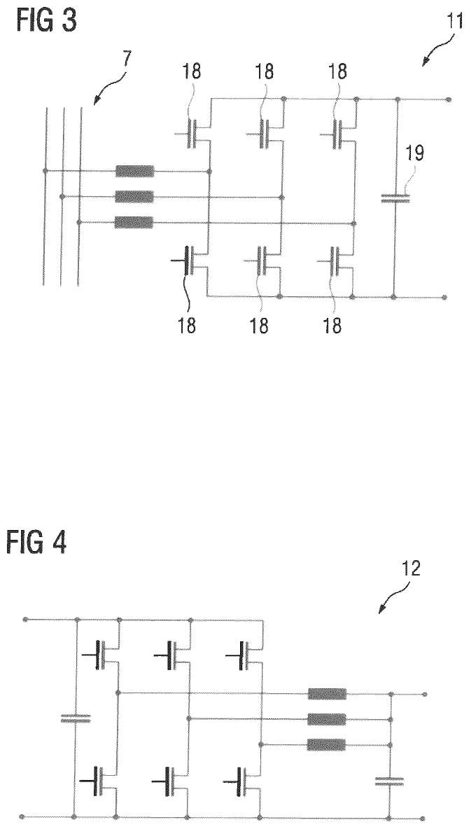

The transistor power converter 11 is advantageously designed as a voltage rectifier according to the illustration in FIG. 3. A capacitor is therefore arranged downstream of transistors which perform the rectification as such on the DC side. The transistor power converter 11 in particular also enables a bidirectional energy flow due to the circuitry of FIG. 3, i.e. both from the secondary side 14 of the second transformer arrangement 10 to the DC-DC converter 12 and vice versa from the DC-DC converter 12 to the secondary side 14 of the second transformer arrangement 10. Chokes arranged toward the AC voltage grid 7 are not marked with a reference character. Diodes connected in parallel to the transistors 18 are likewise present, but are not show in FIG. 3 for the sake of clarity.

The DC-DC converter 12 is advantageously embodied as an interleaved buck-boost converter in accordance with the illustration in FIG. 4. As a result, the circuit design is similar to the transistor converter 11 with the difference that the chokes in the DC-DC converter 12 are connected to a common node point, which is followed by a capacitor. Existing chokes are also not provided with a reference character. Diodes connected in parallel to the transistors 18 are likewise present, but are not shown in FIG. 4 for the sake of clarity.

Alternatively, the DC-DC converter 12 according to FIG. 5 can be designed as a potential-isolating DC-DC converter. For example, in this case the DC-DC converter 12 can comprise an inverter 20, a transformer 21 arranged downstream of the inverter 20 and a rectifier 22 arranged downstream of the transformer 21. If necessary, the rectifier 22 may be upstream or downstream of another circuit which is constructed analogously to the circuit in FIG. 4.

Due to the DC-DC converter 12, a current ripple that occurs on the output side of the rectifier 3 (i.e. on the DC side) and cannot be compensated for by the transistor power converter 11 as such can be compensated or at least reduced. A filter inductance 23 required in the prior art can therefore be omitted or at least designed to be significantly smaller. This fact is indicated in FIGS. 1 and 2 in that the filter inductance 23 is drawn but crossed out.

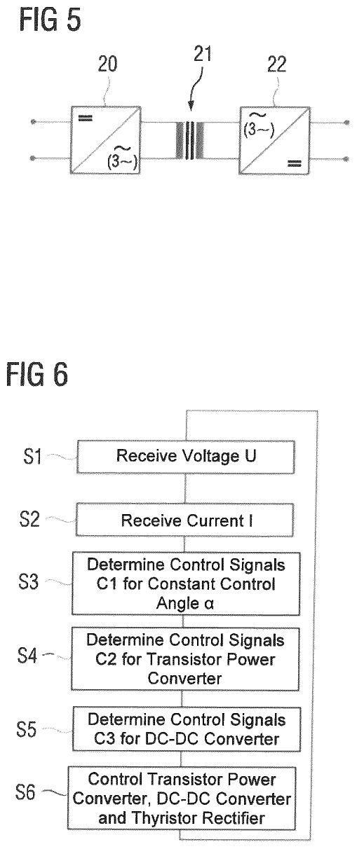

The control facility 15—prompted by commands 17—prefers to carry out an operating method, which is explained in more detail below in conjunction with FIG. 6.

According to FIG. 6, the control facility 15 receives (at least) one voltage U in a step S1. The voltage U is detected by a voltage sensor 24 on the input side of the rectifier 3. Detection can take place on the primary side 5 or on the secondary side 6 of the first transformer arrangement 4 as required.

In a step S2, the control facility 15 receives a current I. The current I is detected by means of a current sensor 25 on the output side of the rectifier 3 and the additional unit 9.

In a step S3, the control facility 15 determines the control signals C1 for the rectifier 3 if the rectifier 3 is designed as a thyristor rectifier. The control signals C1 are determined in this case in that during stationary operation they correspond to a constant control angle α of the thyristor rectifier, in particular to a control angle of 0°. In the case of the design of rectifier 3 as a diode rectifier, step S3 can be omitted.

In a step S4, the control facility 15 determines the control signals C2 for the transistor power converter 11. The control signals C2 are determined such that an amplitude of the alternating voltage supplied to the rectifier 3 is set in such a way that the rectifier 3 makes available a predetermined voltage level toward the DC link 8 and system perturbations occurring during operation of the rectifier 3 toward the AC voltage grid 7 are compensated for as far as possible. The control signals C2 are thus determined in such a way that an effective value of the voltage U approaches a target voltage U* as far as possible and harmonic components are compensated for as far as possible. The regulation of step S4 is therefore related to the instantaneous value of the voltage U and not to the value averaged over a period of alternating voltage.

In a step S5, the control facility 15 determines the control signals C3 for the DC-DC converter 12. The control signals C3 are determined in such a way that fluctuations of the current I in the DC link 8 are compensated for as far as possible. When determining the control signals C3, the control facility 15 takes account of the electrical balance of the transistor power converter 11, as it results from the control of the transistor power converter 11 in accordance with the control signals C2. The control signals C3 are therefore determined in such a way that the current I is a target current I* as far as possible. Corresponding evaluations to determine the current ripple are generally known to persons skilled in the art. Similarly to step S4, the regulation of step S5 is related to the instantaneous value but not to the value averaged over a period of alternating voltage.

In a step S6, the control facility 15 controls the transistor power converter 11 and the DC-DC converter 12 and, if necessary, also the thyristor rectifier 3 in accordance with the control signals C1, C2, C3 determined in steps S3 to S5.

At the same time, FIG. 6 also shows two advantageous embodiments of the operating method.

On the one hand, according to the illustration in step S3, the energy E drawn from the transistor power converter 11 on the input side can be positive or negative as required—but of course not at the same time. The additional unit 9—more precisely: the transistor power converter 11—is controlled by the control facility 15 in such a way that if necessary it feeds energy into the DC link 8 in order to compensate for voltage fluctuations as a function of the acquired alternating voltage U or draws energy from the DC link 8.

On the other hand, the energy E flowing via the additional unit 9 is limited by the control facility 15 to a value that is at most 20% of the electrical energy E′ flowing via the thyristor rectifier 3. Advantageously, there is even a limit to a lower value of no more than 15%. Accordingly, the additional unit 9 is controlled by the control facility 15.

The present invention has many advantages. In particular, the topology of the circuit is simple, robust and reliable. The corresponding units (rectifier 3, transistor converter 11, DC-DC converter 12) and their control are generally known as such. The implementation of the invention is therefore simple and inexpensive. The current ripple can be reliably reduced to a considerable extent. Furthermore, the DC-DC converter 12 can protect the transistor power converter 11 in the event of a short circuit in the DC link 8.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A power supply facility for supplying electrical energy to an electrolysis plant, comprising:
a first transformer arrangement comprising
a primary side and a secondary side,
a rectifier drawing electrical energy from an AC voltage grid via the first transformer arrangement and supplying the electrical energy to the electrolysis plant via a DC link; and
an additional unit comprising a second transformer arrangement having a primary side connected in series to the primary side or to the secondary side of the first transformer arrangement and a secondary side, a DC-DC converter connected to the DC link of the rectifier, and
a transistor power converter connected to the secondary side of the second transformer arrangement and to the DC-DC converter.

2. The power supply facility of claim 1, wherein the additional unit is dimensioned for a smaller electrical energy flow than the rectifier.

3. The power supply facility of claim 1, wherein the DC-DC converter is constructed as an interleaved buck-boost converter.

4. The power supply facility of claim 1, wherein the DC-DC converter is constructed as a galvanically isolated DC-DC converter.

5. The power supply facility of claim 1, wherein the transistor power converter is constructed as a voltage rectifier.

6. The power supply facility of claim 1, wherein the transistor power converter is constructed as an inverter enabling a bidirectional energy flow or as a rectifier enabling only a unidirectional energy flow.

7. A method for operating a power supply facility for supplying electrical energy to an electrolysis plant as set forth in claim 1, the method comprising:
controlling the transistor power converter such that an amplitude of an alternating voltage supplied to the rectifier supplies a predetermined voltage level to the DC link to significantly compensate system perturbations occurring on the AC voltage grid during operation of the rectifier, and
controlling the DC-DC converter by taking into account the electrical balance of the transistor power converter produced by the control of the transistor power converter so as to compensate current fluctuations in the DC link of the rectifier as far as possible.

8. The method of claim 7, wherein the additional unit for compensating the voltage fluctuations is controlled as a function of an alternating voltage measured at the input side of the rectifier so as to feeding energy into the DC link of the rectifier or removing energy from the DC link of the rectifier, as required.

9. The method of claim 7, wherein the rectifier is constructed as a thyristor rectifier, the method comprising controlling the thyristor rectifier during stationary operation with a constant control angle.

10. The method of claim 9, wherein the control angle is 0°.

11. A control program embodied on a non-transitory medium and comprising computer-executable control commands, which when read into a memory of a control facility for a power supply facility as set forth in claim 1 and executed by a processor of the control facility cause the control facility to control the power supply facility by
controlling the transistor power converter such that an amplitude of an alternating voltage supplied to the rectifier supplies a predetermined voltage level to the DC link to significantly compensate system perturbations occurring on the AC voltage grid during operation of the rectifier, and
controlling the DC-DC converter by taking into account the electrical balance of the transistor power converter produced by the control of the transistor power converter so as to compensate current fluctuations in the DC link of the rectifier as far as possible.

12. A control facility, wherein the control facility is programmed with the control program as claimed in claim 11 so as to control a power supply facility with the control facility during operation.
